(19) United States
(12) Patent Application Publication
(10) Pub. No.: US 2012/0025564 A1
(43) Pub. Date: Feb. 2, 2012

(54) Flush Glass System Module

(75) Inventors: Peter J. ELLIS, Rochester Hills, MI (US); Anthony A. LENICZEK, Troy, MI (US)

(73) Assignee: Magna International Inc., Aurora (CA)

(21) Appl. No.: 13/189,946

(22) Filed: Jul. 25, 2011

Related U.S. Application Data
(60) Provisional application No. 61/400,496, filed on Jul. 28, 2010.

(51) Int. Cl. B60J 10/02

(52) U.S. Cl. 296/146.9

(57) ABSTRACT

A flush glass system module includes a header molding that is mounted to a vehicle door frame and extends along an upper edge of a window opening. A belt molding is mounted to the door frame and extends along a lower edge of the window opening. A hidden appliqué extends between the header molding and the belt molding. The hidden appliqué is extruded and includes a guidance channel having a pair of sealing lips. The guidance channel is adapted for receiving and guiding a window between raised and lowered positions. A slider is mounted to an inner surface of the window and is received in the guidance channel. The sealing lips sealingly engage with the slider as the window moves between the lowered and raised positions. The hidden appliqué is disposed entirely on the inner surface side of the window when the window is in the raised position.

### BACKGROUND

1. Field of the Invention

The invention relates to a window surround assembly for an automotive vehicle door. More particularly, the invention relates to a flush glass system module including an extruded hidden appliqué.

2. Description of Related Art

A conventional automotive vehicle door assembly typically includes a door frame having a window opening and a glass window. The window can be selectively raised to close the window opening and lowered to open the window opening. A window surround assembly is commonly used around the window opening to seal any gaps around the raised window and to guide the window as it is raised and lowered. The seal is required to prevent the outside elements from entering the passenger compartment and contacting either the passenger or the interior of the vehicle.

The window surround assembly includes a header molding (also referred to as an upper reveal) mounted to the door frame and extending along an upper edge of the window opening; a belt molding (also referred to as a belt line) mounted to the door frame and extending along a lower edge of the window opening; and front and rear vertical moldings (also referred to as glass run channels) mounted to the door frame and extending along front and rear vertical edges of the window opening. The glass run channels engage the front and rear vertical edges of the window during movement of the window between the raised and lowered positions. Often, decorative covers or appliqués are attached to the glass run channels to improve the exterior appearance of the glass run channels. However, the decorative covers may project beyond an outer surface of the window creating aerodynamic drag, detracting from the vehicle's aesthetics, and limiting vehicle styling.

It is desirable, therefore, to provide a flush glass system module for a door of a motor vehicle including an appliqué´ that is hidden behind a window in a raised position allowing the window to mount flush with surrounding features on the vehicle.

### SUMMARY

According to one aspect of the invention, a flush glass system module is provided for a motor vehicle door frame defining a window opening. The flush glass system module includes a header molding that is mounted to the door frame and extends along an upper edge of the window opening. A belt molding is mounted to the door frame and extends along a lower edge of the window opening. A hidden appliqué extends between the header molding and the belt molding. The hidden appliqué is extruded and includes a guidance channel having a pair of first sealing lips. A slider is mounted to an inner surface of a window and is received in the guidance channel for guiding the window between raised and lowered positions. The pair of first sealing lips sealingly engages with the slider as the window moves between the raised and lowered positions. The hidden appliqué is disposed entirely on the inner surface side of the window when the window is in the raised position. The hidden appliqué may also include a second sealing lip sealingly engaging with the inner surface of the window as the window moves between the raised and lowered positions.

### BRIEF DESCRIPTION OF THE DRAWINGS

The invention will be readily appreciated as the same becomes better understood by reference to the following detailed description when considered in connection with the accompanying drawings wherein:

FIG. 1 is a fragmentary, side view of a motor vehicle including a flush glass system module for front and rear doors;

FIG. 2 is a side view of the flush glass system module;

FIG. 3 is a cross-sectional view taken through lines 3-3 in FIG. 2;

FIG. 4 is a cross-sectional view taken through lines 4-4 in FIG. 2; and

FIG. 5 is a cross-sectional view taken through lines 5-5 in FIG. 2.

### DETAILED DESCRIPTION OF THE EMBODIMENTS

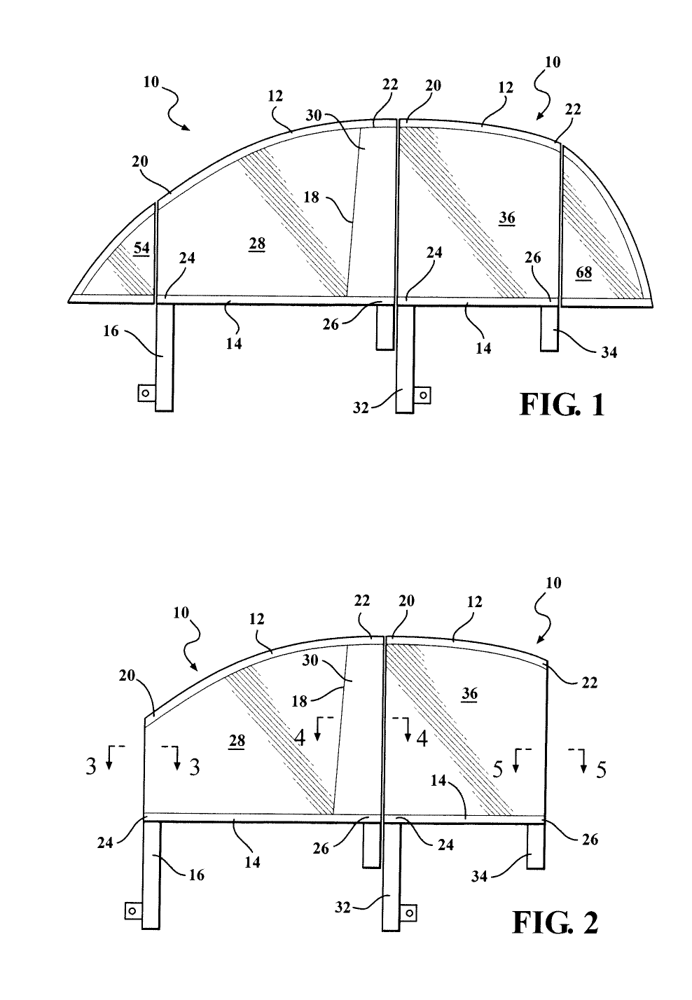

Referring to FIGS. 1 and 2, a flush glass system module, generally shown at 10, is provided for front and rear doors of a motor vehicle. The flush glass system module 10 for the front door includes a header molding 12, a belt molding 14, an A-pillar appliqué 16, and a forward B-pillar appliqué 18. The header molding 12 is adapted to be mounted to an upper flange of the front door and extends along an upper edge of a front window opening, as is well known in the art. The header molding 12 extends between a front end 20 and a back end 22, and conforms to the curvature of the upper edge of the front window opening. The belt molding 14 is adapted to be mounted to a lower flange of the front door along a lower edge of the front window opening, as is well known in the art. The belt molding 14 is generally linear and extends between a front end 24 and a back end 26. The A-pillar appliqué 16 extends between the front end 20 of the header molding 12 and the front end 24 of the belt molding 14. The A-pillar appliqué 16 extends downwardly into the interior of the front door below the belt molding 14. The forward B-pillar appliqué 18 extends between the back end 22 of the header molding 12 and the back end 26 of the belt molding 14. The forward B-pillar appliqué 18 extends downwardly into the interior of the front door below the belt molding 14.

A retractable front window 28 is guided by the A-pillar appliqué 16 and the forward B-pillar appliqué 18 between raised and lowered positions. With the front window 28 in the raised position and the front door in a closed position, the A-pillar appliqué 16 is disposed or hidden behind the front window 28 such that the A-pillar appliqué´ 16 is not exposed along an exterior of the vehicle. In contrast, with the front window 28 in the raised position and the front door in the closed position, the forward B-pillar appliqué 18 is disposed adjacent to a rear edge of the front window 28 such that the forward B-pillar appliqué 18 is exposed along the exterior of the vehicle. A decorative cover 30 is fixedly secured to the forward B-pillar appliqué 18 for aesthetic purposes, as is well known in the art. The cover 30 is an elongated one-piece stamped member that extends along the length of the forward B-pillar appliqué 18 between the header molding 12 and the belt molding 14. The cover 30 may be formed from any of numerous materials, including, but not limited to, stainless steel, aluminum, and a molded material having a high gloss black with film. It is contemplated that the forward B-pillar appliqué´ 18 could be replaced with an appliqué´ similar to the A-pillar appliqué´ 16 such that it would be disposed behind the front window 28 when the front window 28 is in the raised position and the front door is in the closed position, without varying from the scope of the invention. In such an arrangement the cover 30 would not be required.

The flush glass system module 10 for the rear door of the motor vehicle includes the header molding 12, the belt molding 14, a rearward B-pillar appliqué´ 32, and a C-pillar appliqué 34. The rearward B-pillar appliqué´ 32 extends between the front end 20 of the header molding 12 and the front end 24 of the belt molding 14. The rearward B-pillar appliqué 32 extends downwardly into the interior of the rear door below the belt molding 14. The C-pillar appliqué 34 extends between the back end 22 of the header molding 12 and the back end 26 of the belt molding 14. The C-pillar appliqué´ 34 extends downwardly into the interior of the rear door below the belt molding 14.

A retractable rear window 36 is guided by the rearward B-pillar appliqué 32 and the C-pillar appliqué´ 34 between raised and lowered positions. With the rear window 36 in the raised position and the rear door in a closed position, the rearward B-pillar appliqué´ 32 and the C-pillar appliqué´ 34 are disposed behind the rear window 36 such that the rearward B-pillar appliqué´ 32 and the C-pillar appliqué´ 34 are not exposed along the exterior of the vehicle. The flush glass system module 10 for each of the front and rear doors is a modular assembly that can be pre-assembled away from the motor vehicle and then shipped as a single piece for installation to the respective front and rear doors.

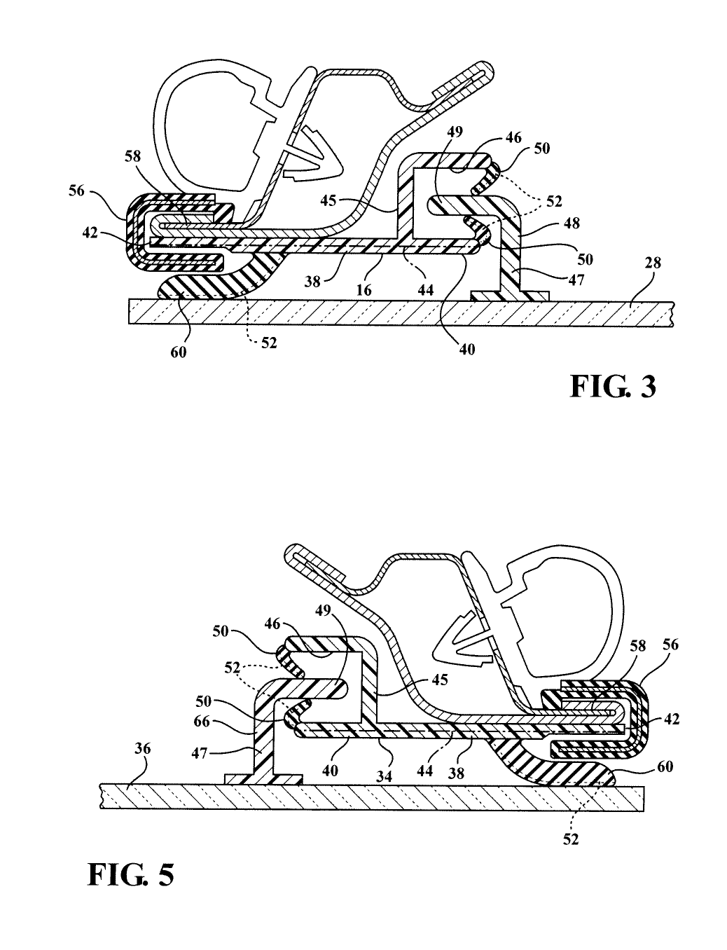

Each of the A-pillar appliqué´ 16, the rearward B-pillar appliqué´ 32, and the C-pillar appliqué 34 are substantially similar in design and method of fabrication and only the A-pillar appliqué 16 will be described in detail. Referring to FIG. 3, the A-pillar appliqué 16 is formed using an extrusion process and includes a main body portion 38 extending between a first end 40 and a second end 42. The main body portion 38 may be formed from any of numerous materials, including, but not limited to, thermoplastic vulcanisate (TPV), ethylene propylene diene monomer (EPDM), polyvinyl chloride (PVC), and polypropylene or other plastic material. A carrier 44 may be embedded within the main body portion 38 to provide added structural support therefor. In one embodiment, the carrier 44 is a metal material. The first end 40 of the main body portion 38 includes a generally U-shaped portion 45 defining a guidance channel 46 for receiving a front slider 48 that is bonded to an inner surface of the front window 28. The front slider 48 is generally L-shaped and includes a first portion 47 extending generally perpendicularly to the inner surface of the front window 28 and a second portion 49 extending generally parallel to the inner surface of the front window 28. A pair of first sealing lips 50 is formed in the guidance channel 46 for sealingly engaging with the front slider 48 as the front window 28 moves between the raised and lowered positions. More specifically, the pair of first sealing lips 50 directly engage the second portion 49 of the front slider 48. The pair of first sealing lips 50 is co-extruded with the A-pillar appliqué 16 and may be formed from any of numerous materials, including, but not limited to, TPV, EPDM, PVC, and polypropylene or other plastic material. It is appreciated that the composition of the pair of first sealing lips 50 may be different than the composition of the main body portion 38 to allow for the desired flexibility and sealing characteristics of the pair of first sealing lips 50. A surface on the pair of first sealing lips 50 directly engaging the front slider 48 may include a low friction slip coating or film 52 that is applied by any of numerous methods, including, but not limited to extrusion, spraying, and flocking. It is contemplated that controlling the thickness of the U-shaped portion 45 near the main body portion 38 during the extrusion process will establish a curvature of the A-pillar appliqué 16 in the vertical plane that corresponds to the curvature of the front window 28.

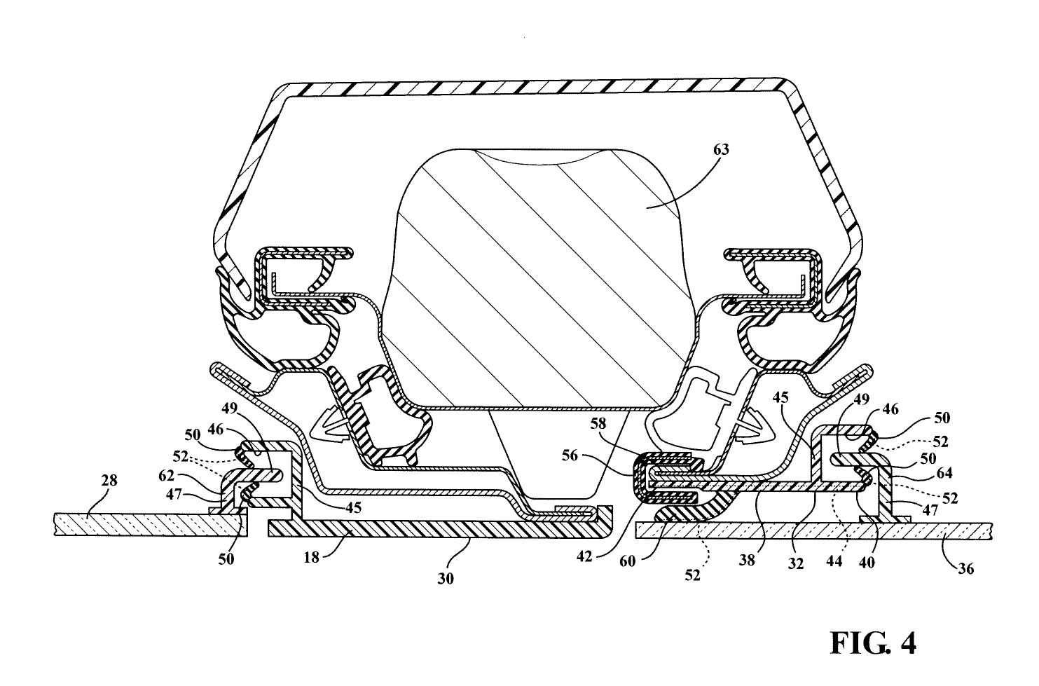

A plurality of clips 56 is disposed along the second end 42 of the main body portion 38 to secure the A-pillar appliqué´ 16 to a flange 58 of the front door adjacent an A-pillar (not shown) of the vehicle. The A-pillar appliqué´ 16 further includes a second sealing lip 60 extending from the main body portion 38 for sealingly engaging the front window 28 when the front window 28 is in the raised position. More specifically, the second sealing lip 60 directly engages the inner surface of the front window 28. The second sealing lip 60 is co-extruded with the A-pillar appliqué 16 and may be formed from any of numerous materials, including those listed above with respect to the pair of first sealing lips 50. Similarly, a surface of the second sealing lip 60 directly engaging the front window 28 may also include the low friction slip coating or film 52 that is applied by any of numerous methods, including, but not limited to extrusion, spraying, and flocking. The front slider 48 and the A-pillar appliqué´ 16 are adapted such that the front window 28 is offset laterally from the guidance channel 46 of the A-pillar appliqué´ 16 in a cross-car direction thereby positioning an outer surface of the front window 28 generally flush or in the same plane with a forward window or forward body panel 54, shown in FIG. 1, that is fixed to the vehicle. A rear slider 62 and the forward B-pillar appliqué´ 18 are disposed adjacent a B-pillar 63 of the vehicle and are adapted such that the front window 28 is offset laterally from the guidance channel 46 of the forward B-pillar appliqué´ 18 in the cross-car direction thereby positioning the outer surface of the front window 28 generally flush or in the same plane with the forward B-pillar appliqué´ 18 or the cover 30 affixed thereto, as shown in FIG. 4.

Referring to FIGS. 4 and 5, a front slider 64 and the rearward B-pillar appliqué 32 are disposed adjacent the B-pillar 63 and are adapted such that the rear window 36 is offset laterally from the guidance channel 46 of the rearward B-pillar appliqué´ 32 in the cross-car direction thereby positioning an outer surface of the rear window 36 generally flush or in the same plane with the forward B-pillar appliqué 18 or the cover 30. A rear slider 66 and the C-pillar appliqué 34 are adapted such that the rear window 36 is offset laterally from the guidance channel 46 of the C-pillar appliqué´ 34 in the cross-car direction thereby positioning the outer surface of the rear window 36 generally flush or in the same plane with a rearward window or rearward body panel 68, shown in FIG. 1, that is fixed to the vehicle.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A flush glass system module for a motor vehicle door frame defining a window opening having an upper edge and a lower edge for receiving a window having an inner surface, said flush glass system module comprising:
a front slider adapted to mount to the inner surface of the window; and
a first appliqué´ includes a guidance channel adapted for receiving and guiding said front slider as the window moves between raised and lowered positions, wherein said first appliqué´ is disposed entirely on the inner surface side of the window.

2. The flush glass system module as set forth in claim 1 including a header molding adapted to mount to the upper edge of the window opening and a belt molding adapted to mount to the lower edge of the window opening, wherein said header molding extends between a front end and a back end, and wherein said belt molding extends between a front end and a back end.

3. The flush glass system module as set forth in claim 2 wherein said first appliqué´ extends between said front end of said header molding and said front end of said belt molding.

4. The flush glass system module as set forth in claim 3 wherein said guidance channel includes a pair of first sealing lips directly engaging said front slider.

5. The flush glass system module as set forth in claim 4 wherein each of said pair of first sealing lips includes a low friction slip coating directly engaging said front slider.

6. The flush glass system module as set forth in claim 4 wherein said first appliqué´ includes a second sealing lip adapted to directly engage the inner surface of the window as the window moves between the raised and lowered positions.

7. The flush glass system module as set forth in claim 6 wherein said second sealing lip includes a low friction slip coating adapted to directly engage the inner surface of the window as the window moves between the raised and lowered positions.

8. The flush glass system module as set forth in claim 6 wherein said first appliqué´ extends below said belt molding away from said header molding.

9. The flush glass system module as set forth in claim 1 including a rear slider adapted to mount to the inner surface of the window and a second appliqué, wherein said second appliqué extends between said back end of said header molding and said back end of said belt molding, said second appliqué´ including a guidance channel adapted for receiving and guiding said rear slider as the window moves between raised and lowered positions.

10. The flush glass system module as set forth in claim 9 wherein said guidance channel of said second appliqué includes a pair of first sealing lips directly engaging said rear slider.

11. The flush glass system module as set forth in claim 10 wherein each of said pair of first sealing lips of said second appliqué includes a low friction slip coating directly engaging said rear slider.

12. The flush glass system module as set forth in claim 9 wherein said second appliqué is disposed entirely on the inner surface side of the window.

13. The flush glass system module as set forth in claim 10 wherein said second appliqué extends below said belt molding away from said header molding.

14. In combination, a window and a flush glass system module for a motor vehicle door frame defining a window opening having an upper edge and a lower edge, said combination comprising:
a window including an inner surface and an outer surface, said inner surface defining an inner surface side of said window;
a front slider mounted to said inner surface of said window;
a header molding adapted to mount to the upper edge of the window opening, said header molding extending between a front end and a back end;
a belt molding adapted to mount to the lower edge of the window opening, said belt molding extending between a front end and a back end; and
a first appliqué extending between said front end of said header molding and said front end of said belt molding, said first appliqué including a guidance channel adapted for receiving and guiding said front slider as said window moves between raised and lowered positions, wherein said first appliqué´ is disposed entirely on said inner surface side of said window.

15. The combination as set forth in claim 14 wherein said window is offset laterally from said guidance channel.

16. The combination as set forth in claim 14 wherein said first appliqué´ includes a main body extending between a first end and a second end, said first end defining said guidance channel, and said second end adapted to be fixedly secured to the door frame, wherein said main body of said first appliqué´ is spaced apart from said inner surface of said window.
